(19) United States
(12) Patent Application Publication
(10) Pub. No.: US 2011/0238743 A1
(43) Pub. Date: Sep. 29, 2011

(54) ELECTRONIC DEVICE CONTROLLING SYSTEM AND ELECTRONIC DEVICE CONTROLLING METHOD

(75) Inventor: Yumiko Kikuoka, Osaka (JP)

(73) Assignee: SHARP KABUSHIKI KAISHA, Osaka (JP)

(21) Appl. No.: 13/071,885

(22) Filed: Mar. 25, 2011

(30) Foreign Application Priority Data
Mar. 25, 2010 (JP) 2010-069805

(51) Int. Cl. G06F 15/16

(52) U.S. Cl. 709/203

(57) ABSTRACT

A terminal transmits user information, user information and function setting information used in the electronic device, or output data including user information and function setting information to the server. The server reads out limit function information/alternative function information each of which is correlated to the transmitted user information, and transmits the above information as it is, or transmits the information by changing a part of the function setting information in the output data, that corresponds to the limit function information, into the alternative function information, or transmits the output data thus changed, to the terminal. The terminal generates and displays a preview image of output data based on the transmitted information.

### CROSS-NOTING PARAGRAPH

This non-provisional application claims priority under 35 U.S.C. §119(a) on Patent Application No. 2010-069805 filed in JAPAN on Mar. 25, 2010, the entire contents of which are hereby incorporated herein by reference.

### FIELD OF THE INVENTION

The present invention relates to an electronic device controlling system in which a server, a client terminal and an electronic device are connected on a network and a electronic device controlling method.

### BACKGROUND OF THE INVENTION

In an electronic device controlling system in which a server, a client terminal and an electronic device are connected to a network for controlling the electronic device, a technology is known that a limiting function of the electronic device is controlled and managed in an integrated fashion on the server side (refer to, for example, Japanese Laid-Open Patent Publication No. 2006-172094).

However, in the system described in Japanese Laid-Open Patent Publication No. 2006-172094, the limiting function is set by an administrator, but a user can not confirm whether or not desired output can be carried out due to the function limit before output.

### SUMMARY OF THE INVENTION

An object of the present invention is to provide an electronic device controlling system which comprises an electronic device capable of outputting data and a server on a network, wherein a limiting function (limit function) for the electronic device and an alternative function therefor are able to be managed in an integrated fashion on the server side for each account information or for each user type, and allows a user to confirm contents of the data to be output in advance before output, when the user operates a client terminal to output data by the electronic device, or when user directly operates the electronic device to output data stored in the server, or when a user directly operates the electronic device to output data in the electronic device.

A first technical means of the present invention is an electronic device controlling system in which a server, a client terminal and an electronic device capable of outputting data via the server in response to an instruction from the client terminal are connected to a network, wherein the server comprises a limit information storing portion for storing user information, limit function information showing a function usage of which is limited among functions of the electronic device, and alternative function information showing a function used as an alternative for the limiting function by correlating the above information to each other, the client terminal comprises a terminal-side information transmitting portion for transmitting the user information to the server, the server further comprises a searching portion for searching whether or not the user information transmitted from the terminal-side information transmitting portion is stored in the limit information storing portion, and reading out the limit function information and the alternative function information each of which is correlated to the user information when the user information is stored, and a changed information transmitting portion for transmitting the limit function information and the alternative function information read out by the searching portion to the client terminal, and the client terminal further comprises a preview display portion for generating and displaying a preview image of output data based on the limit function information and the alternative function information transmitted from the changed information transmitting portion.

A second technical means is the electronic device controlling system in which a server, a client terminal and an electronic device capable of outputting data via the server in response to an instruction from the client terminal are connected to a network, wherein the server comprises a limit information storing portion for storing user information, limit function information showing a function usage of which is limited among functions of the electronic device, and alternative function information showing a function used as an alternative for the limiting function by correlating the above information to each other, the client terminal comprises a terminal-side information transmitting portion for transmitting the user information and function setting information used in the electronic device to the server, the server further comprises a searching portion for searching whether or not the user information transmitted from the terminal-side information transmitting portion is stored in the limit information storing portion, and reading out the limit function information and the alternative function information each of which is correlated to the user information when the user information is stored, and a changed information transmitting portion for changing a part of the function setting information, that corresponds to the limit function information, into the alternative function information based on the limit function information and the alternative function information read out by the searching portion, and transmitting the changed function setting information to the client terminal, and the client terminal further comprises a preview display portion for generating and displaying a preview image of output data based on the changed function setting information transmitted from the changed information transmitting portion.

A third technical means is the electronic device controlling system in which a server, a client terminal and an electronic device capable of outputting data via the server in response to an instruction from the client terminal are connected to a network, wherein the server comprises a limit information storing portion for storing user information, limit function information showing a function usage of which is limited among functions of the electronic device, and alternative function information showing a function used as an alternative for the limiting function by correlating the above information to each other, the client terminal comprises a terminal-side information transmitting portion for transmitting output data including the user information and function setting information used in the electronic device to the server, the server further comprises a searching portion for searching whether or not the user information transmitted from the terminal-side information transmitting portion is stored in the limit information storing portion, and reading out the limit function information and the alternative function information each of which is correlated to the user information when the user information is stored, and a changed information transmitting portion for changing a part of the function setting information in the output data, that corresponds to the limit function information, into the alternative function information based on the limit function information and the alternative function information read out by the searching portion, and transmitting the changed output data to the client terminal, and the client terminal further comprises a preview display portion for generating and displaying a preview image of output data based on the changed output data transmitted from the changed information transmitting portion.

A fourth technical means is the electronic device controlling system in which a server and an electronic device capable of outputting data are connected to a network, wherein the server comprises a limit information storing portion for storing user information, limit function information showing a function usage of which is limited among functions of the electronic device, and alternative function information showing a function used as an alternative for the limiting function by correlating the above information to each other, the electronic device comprises a device-side information transmitting portion for transmitting the user information to the server, the server further comprises a searching portion for searching whether or not the user information transmitted from the device-side information transmitting portion is stored in the limit information storing portion, and reading out the limit function information and the alternative function information each of which is correlated to the user information when the user information is stored, and a changed information transmitting portion for transmitting the limit function information and the alternative function information read out by the searching portion to the electronic device, and the electronic device further comprises a preview display portion for generating and displaying a preview image of output data based on the limit function information and the alternative function information transmitted from the changed information transmitting portion.

A fifth technical means is the electronic device controlling system in which a server and an electronic device capable of outputting data are connected to a network, wherein the server comprises a limit information storing portion for storing user information, limit function information showing a function usage of which is limited among functions of the electronic device, and alternative function information showing a function used as an alternative for the limiting function by correlating the above information to each other, the electronic device comprises a device-side information transmitting portion for transmitting the user information and function setting information used in the electronic device to the server, the server further comprises a searching portion for searching whether or not the user information transmitted from the device-side information transmitting portion is stored in the limit information storing portion, and reading out the limit function information and the alternative function information each of which is correlated to the user information when the user information is stored, and a changed information transmitting portion for changing a part of the function setting information, that corresponds to the limit function information, into the alternative function information, based on the limit function information and the alternative function information read out by the searching portion, and transmitting the changed function setting information to the electronic device, and the electronic device further comprises a preview display portion for generating and displaying a preview image of output data based on the changed function setting information transmitted from the changed information transmitting portion.

A sixth technical means is the electronic device controlling system in which a server and an electronic device capable of outputting data are connected to a network, wherein the server comprises a limit information storing portion for storing user information, limit function information showing a function usage of which is limited among functions of the electronic device, and alternative function information showing a function used as an alternative for the limiting function by correlating the above information to each other, the electronic device comprises a device-side information transmitting portion for transmitting output data including the user information and function setting information used in the electronic device to the server, the server further comprises a searching portion for searching whether or not the user information transmitted from the device-side information transmitting portion is stored in the limit information storing portion, and reading out the limit function information and the alternative function information each of which is correlated to the user information when the user information is stored, and a changed information transmitting portion for changing a part of the function setting information in the output data, that corresponds to the limit function information, into the alternative function information, based on the limit function information and the alternative function information read out by the searching portion, and transmitting the changed output data to the electronic device, and the electronic device further comprises a preview display portion for generating and displaying a preview image of output data based on the changed output data transmitted from the changed information transmitting portion.

A seventh technical means is an electronic device controlling method in an electronic device controlling system in which a server, a client terminal and an electronic device capable of outputting data via the server in response to an instruction from the client terminal are connected to a network, comprising: a limit information storing step in which the server stores user information, limit function information showing a function usage of which is limited among functions of the electronic device, and alternative function information showing a function used as an alternative for the limiting function by correlating the above information to each other; a terminal-side information transmitting step in which the client terminal transmits the user information to the server; a searching step in which the server searches whether or not the user information transmitted at the terminal-side information transmitting step is stored at the limit information storing step, and reads out the limit function information and the alternative function information each of which is correlated to the user information when the user information is stored; a changed information transmitting step in which the server transmits the limit function information and the alternative function information read out at the searching step to the client terminal; and a preview display step in which the client terminal generates and displays a preview image of output data based on the limit function information and the alternative function information transmitted at the changed information transmitting step.

An eighth technical means is the electronic device controlling method in an electronic device controlling system in which a server, a client terminal and an electronic device capable of outputting data via the server in response to an instruction from the client terminal are connected to a network, comprising: limit information storing step in which the server stores user information, limit function information showing a function usage of which is limited among functions of the electronic device, and alternative function information showing a function used as an alternative for the limiting function by correlating the above information to each other; a terminal-side information transmitting step in which the client terminal transmits the user information and function setting information used in the electronic device to the server; a searching step in which the server searches whether or not the user information transmitted at the terminal-side information transmitting step is stored at the limit information storing step, and reads out the limit function information and the alternative function information each of which is correlated to the user information when the user information is stored; a changed information transmitting step in which the server changes a part of the function setting information, that corresponds to the limit function information, into the alternative function information, based on the limit function information and the alternative function information read out at the searching step, and transmits the changed function setting information to the client terminal; and a preview display step in which the client terminal generates and displays a preview image of output data based on the changed function setting information transmitted at the changed information transmitting step.

A ninth technical means is the electronic device controlling method in an electronic device controlling system in which a server, a client terminal and an electronic device capable of outputting data via the server in response to an instruction from the client terminal are connected to a network, comprising: a limit information storing step in which the server stores user information, limit function information showing a function usage of which is limited among functions of the electronic device, and alternative function information showing a function used as an alternative for the limiting function by correlating the above information to each other; a terminal-side information transmitting step in which the client terminal transmits output data including the user information and function setting information used in the electronic device to the server; a searching step in which the server searches whether or not the user information transmitted at the terminal-side information transmitting step is stored at the limit information storing step, and reads out the limit function information and the alternative function information each of which is correlated to the user information when the user information is stored; a changed information transmitting step in which the server changes a part of the function setting information in the output data, that corresponds to the limit function information, into the alternative function information, based on the limit function information and the alternative function information read out at the searching step, and transmits the changed output data to the client terminal; and a preview display step in which the client terminal generates and displays a preview image of output data based on the changed output data transmitted at the changed information transmitting step.

A tenth technical means is the electronic device controlling method in an electronic device controlling system in which a server and an electronic device capable of outputting data are connected to a network, comprising: a limit information storing step in which the server store user information, limit function information showing a function usage of which is limited among functions of the electronic device, and alternative function information showing a function used as an alternative for the limiting function by correlating the above information to each other; a device-side information transmitting step in which the electronic device transmits the user information to the server; a searching step in which the server searches whether or not the user information transmitted at the device-side information transmitting step is stored at the limit information storing step, and reads out the limit function information and the alternative function information each of which is correlated to the user information when the user information is stored; a changed information transmitting step in which the server transmits the limit function information and the alternative function information read out at the searching step to the electronic device; and a preview display step in which the electronic device generates and displays a preview image of output data based on the limit function information and the alternative function information transmitted at the changed information transmitting step.

An eleventh technical means is the electronic device controlling method in an electronic device controlling system in which a server and an electronic device capable of outputting data are connected to a network, comprising: a limit information storing step in which the server stores user information, limit function information showing a function usage of which is limited among functions of the electronic device, and alternative function information showing a function used as an alternative for the limiting function by correlating the above information to each other; a device-side information transmitting step in which the electronic device transmits the user information and function setting information used in the electronic device to the server; a searching step in which the server searches whether or not the user information transmitted at the device-side information transmitting step is stored at the limit information storing step, and reads out the limit function information and the alternative function information each of which is correlated to the user information when the user information is stored; a changed information transmitting step in which the server changes a part of the function setting information, that corresponds to the limit function information, into the alternative function information, based on the limit function information and the alternative function information read out at the searching step, and transmits the changed function setting information to the electronic device; and a preview display step in which the electronic device generates and displays a preview image of output data based on the changed function setting information transmitted at the changed information transmitting step.

A twelfth technical means is the electronic device controlling method in an electronic device controlling system in which a server and an electronic device capable of outputting data are connected to a network, comprising: a limit information storing step in which the server stores user information, limit function information showing a function usage of which is limited among functions of the electronic device, and alternative function information showing a function used as an alternative for the limiting function by correlating the above information to each other; a device-side information transmitting step in which the electronic device transmits output data including the user information and function setting information used in the electronic device to the server; a searching step in which the server searches whether or not the user information transmitted at the device-side information transmitting step is stored at the limit information storing step, and reads out the limit function information and the alternative function information each of which is correlated to the user information when the user information is stored; a changed information transmitting step in which the server changes a part of the function setting information in the output data, that corresponds to the limit function information, into the alternative function information, based on the limit function information and the alternative function information read out at the searching step, and transmits the changed output data to the electronic device; and a preview display step in which the electronic device generates and displays a preview image of output data based on the changed output data transmitted at the changed information transmitting step.

### BRIEF DESCRIPTION OF THE DRAWINGS

FIG. 1 is a block diagram showing a schematic configuration of an electronic device controlling system according to an embodiment of the present invention;

FIG. 2 is a view showing an example of a user table stored in a server in the electronic device controlling system of FIG. 1;

FIG. 3 is a view showing an example of a group user table stored in the server in the electronic device controlling system of FIG. 1;

FIG. 4 is a view showing an example of a function table stored in the server in the electronic device controlling system of FIG. 1;

FIG. 5 is a view showing an example of a limit/alternative table stored in the server in the electronic device controlling system of FIG. 1;

FIG. 6 is a view showing an example of a group management table stored in the server in the electronic device controlling system of FIG. 1;

FIG. 7 is a view showing an example of a function limit management table stored in the server in the electronic device controlling system of FIG. 1;

FIG. 8 is a flowchart for explaining operations on a client terminal in the electronic device controlling system of FIG. 1;

FIG. 9 is a flowchart for explaining operations on the server in the electronic device controlling system of FIG. 1;

FIG. 10 is a flowchart for explaining operations on an electronic device in the electronic device controlling system of FIG. 1; and

FIG. 11 is a flowchart for explaining operations on the electronic device in an electronic device controlling system having another configuration of the present invention.

### PREFERRED EMBODIMENTS OF THE INVENTION

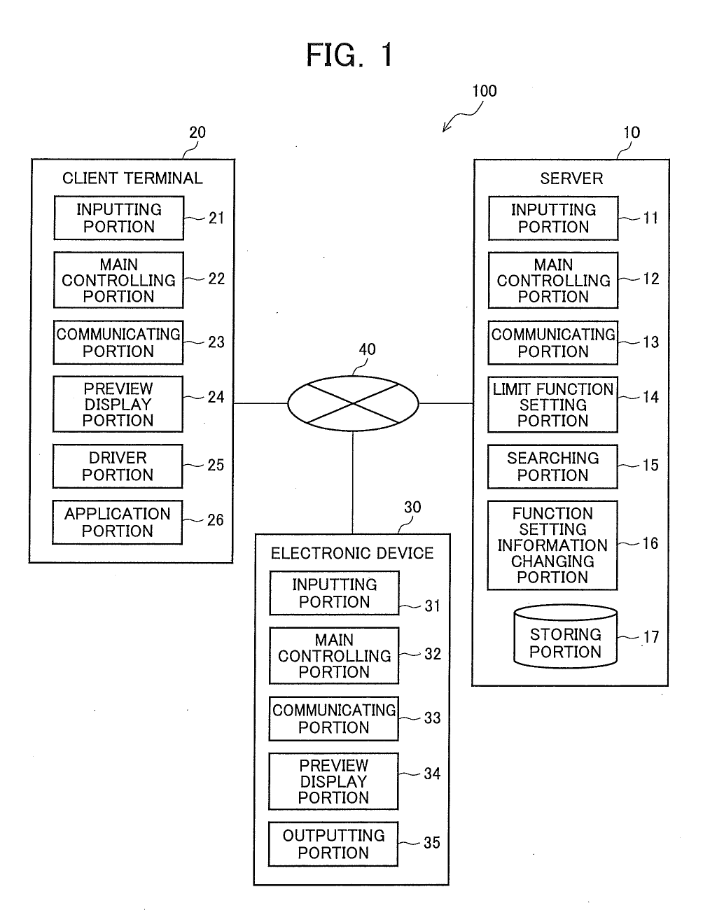

FIG. 1 is a block diagram showing a schematic configuration of an electronic device controlling system according to an embodiment of the present invention. An electronic device controlling system 100 according to the present embodiment illustrated in FIG. 1 has a server 10, a client terminal 20 and an electronic device 30 which are connected via a network 40 and are capable of data communication with each other. The electronic device 30 is capable of outputting data according to the instructions from the client terminal 20 via the server 10. It's preferable that the electronic device 30 is capable of outputting data even by a user operation from an operation portion provided in a main body.

Examples of the electronic device 30 include an image forming apparatus with a single function such as a printer or a facsimile apparatus, and a multifunction peripheral with a plurality of functions such as a print function and a facsimile function. Note that, although a system configuration is described here in which only one client terminal 20 and one electronic device 30 are connected, the system configuration is not limited thereto and is also applicable in the same way to a system in which a plurality of one or both of the client terminal 20 and the electronic device 30 are connected to the network 40. In addition, the following description is applicable in the same way to a system in which different types of electronic devices 30 are connected to the network 40 if it is configured that the server 10 is able to manage functions of each electronic device.

The server 10 is provided with an inputting portion 11, a main controlling portion 12, a communicating portion 13, a limit function setting portion 14, a searching portion 15, a function setting information changing portion 16 and a storing portion 17, and processes data correlating output data from the client terminal 20 to the electronic device 30, a limiting function (limit function) among functions of the electronic device 30, and an alternative function therefor (alternative function), and user account setting and group setting to each other.

The inputting portion 11 receives input for correlating the limit function, the alternative function, and user account setting (and group setting) to each other. Input may be performed from an I/O device on a main body of the server 10, via a Web browser or the like on the client terminal 20, or from an I/O device on the electronic device 30. Note that, although an example mainly employing group management will be shown below, it is possible to configure the electronic device controlling system 100 as a system that processes only accounts of individual users without performing group management.

The main controlling portion 12 is provided with a CPU (Central Processing Unit), a RAM (Random Access Memory) as a working area, a ROM (Read Only Memory) as a storage area of a server program and the like, and controls various functions in the server 10. The communicating portion 13, via the network 40, receives output data from the client terminal 20 to the electronic device 30, transmits information of the account stored in the storing portion 17 and data of the function limit and the alternative function to a driver portion 25 on the client terminal 20, and transmits output data changed into the alternative function to the electronic device 30.

The limit function setting portion 14 sets/stores data correlating the limit function, the alternative function and user account setting and group setting which are input via the inputting portion 11, to each other, to/in the storing portion 17. As illustrated for the limit function setting portion 14 and the storing portion 17, the server 10 is provided with a limit information storing portion for storing user account information or user account information and group setting information, limit function information showing the function the usage of which is limited among functions of the electronic device 30, and alternative function information showing the function used as an alternative for the limiting function by correlating the above information to each other.

The searching portion 15 searches whether or not a user account included in output data to the electronic device 30 that is received from the client terminal 20, a user account used on the driver portion 25 on the client terminal 20 that is received from the client terminal 20, or a user account used on the electronic device 30 that is received from the electronic device 30, is included in the data correlating the limit function, the alternative function, user account setting and group setting to each other, that is stored in the storing portion 17. In this manner, the searching portion 15 searches whether or not information of the user account transmitted from the client terminal 20 is stored in the above-described limit information storing portion. In addition, the searching portion 15 also searches output data based on user account information from the electronic device 30.

Further, as a result of the search, when the user account information is stored, that is, when the user account for the output data to the electronic device 30 that is received from the client terminal 20 or the user account used on the driver portion 25 is included in the above-described correlating data, the searching portion 15 reads out limit function information and alternative function information correlated to the user account information. Note that, although the description is based on the premise that only user account information is transmitted from the client terminal 20 and group setting is only stored in the storing portion 17, it may be configured such that user account information and group setting information are transmitted from the client terminal 20 and the searching portion 15 makes a search from the information transmitted.

In addition, the function setting information changing portion 16 is configured to be able to execute processing 2a described below. Alternatively, it may be configured to be able to execute processing 2b or 2c described below. Note that, the function setting information changing portion 16 can be also configured to be able to execute all or two of three processing 2a to 2c and to actually select and execute one processing among them in accordance with the type of information transmitted from the client terminal 20.

The processing 2a is executed by the function setting information changing portion 16, (1a) when user account information is transmitted from the client terminal 20. The function setting information changing portion 16 transmits limit function information and alternative function information read out by the searching portion 15, that is, information of a limit function and an alternative function therefor corresponding to the user account, as the processing 2a, to the client terminal 20 via the communicating portion 13.

The processing 2b is executed by the function setting information changing portion 16 (1b) when user account information and function setting information used in the electronic device 30 (information showing setting contents in output) are transmitted from the client terminal 20. The function setting information changing portion 16 makes a change to rewrite setting shown by the limit function in the setting contents into setting shown by the alternative function based on information of a limit function and an alternative function therefor corresponding to the user account and transmits the changed function setting information to the client terminal 20 via the communicating portion 13, as the processing 2b. That is, at the processing 2b, a part of the function setting information that corresponds to the limit function information, is changed into the alternative function information based on the limit function information and the alternative function information read out by the searching portion 15, and the changed function setting information is transmitted to the client terminal 20.

The processing 2c is executed by the function setting information changing portion 16 (1c) when output data including user account information and function setting information used in the electronic device 30 is transmitted from the client terminal 20. The function setting information changing portion 16 makes a change to rewrite setting shown by the limit function in the setting contents shown by the output data into setting shown by the alternative function based on limit function information and alternative function information read out by the searching portion 15, and transmits the changed output data to the client terminal 20 via the communicating portion 13, as the processing 2c. That is, at the processing 2c, a part of the function setting information in the output data, that corresponds to the limit function information, is changed into the alternative function information based on the limit function information and the alternative function information read out by the searching portion 15, and the changed output data is transmitted to the client terminal 20.

As illustrated for the function setting information changing portion 16, the storing portion 17 and the communicating portion 13, the server 10 is provided with a following changed information transmitting portion. That is, the changed information transmitting portion executes the above-described processing 2a in the case of the above-described (1a), or executes the above-described processing 2b in the case of the above-described (1b), or executes the above-described processing 2c in the case of the above-described (1c).

In addition, the storing portion 17 temporarily stores output data to the electronic device 30 that is received from the client terminal 20 and that does not run into a limit and output data to the electronic device 30 that has been rewritten by the function setting information changing portion 16 until at least corresponding data is output to the electronic device 30. The output data is the data that is based on the output instruction from the client terminal 20 after preview display to be described at the client terminal 20, that a limit function is changed into an alternative function and that is allowed to be output (function to be limited becomes not included) by the electronic device 30. In other words, the storing portion 17 of the server 10 stores the output data as the output data capable of being output to the electronic device 30 when receiving from the client terminal 20 the instruction to output output data corresponding to a preview image provided for preview display at the client terminal 20.

When the user account used on the electronic device 30 that is received from the electronic device 30 is included in the above-described correlating data, the server 10 reads out output data corresponding to the user account (output data in which a limit function is changed into an alternative function therefor as necessary) and transmits the output data to the electronic device 30 via the communicating portion 13.

The client terminal 20 is comprised of a personal computer (PC), a personal digital assistance (PDA) and the like, and is provided with an inputting portion 21, a main controlling portion 22, a communicating portion 23, a preview display portion 24, the driver portion 25 and an application portion 26 for generating, outputting and providing preview display of data to be output by the electronic device 30. Note that, although the description is based on the premise that data to be output is generated by the client terminal 20, data simply taken from an external recording medium, another client terminal or the like may be an output target.

The inputting portion 21 receives input for generating data in the application portion 26 and for operating the driver portion 25, the preview display portion 24 and the like. The main controlling portion 22 is provided with a CPU, a RAM as a working area, a ROM as a storage area of a program of an operating system and the like, and performs control in the client terminal 20. The communicating portion 23, via the network 40, transmits output data for the electronic device 30 to the server 10, and transmits a user account to the server 10. In this manner, the client terminal 20 is provided with a terminal-side information transmitting portion for transmitting to the server 10 (1a) user account information, (1b) user account information and function setting information used in the electronic device 30 this time or (1c) output data including user account information and function setting information used in the electronic device 30 this time. Moreover, the communicating portion 23 receives data of the function limit and the alternative function corresponding to the user account, that is stored in the storing portion 17 on the server 10.

The preview display portion 24 has a display portion and a preview display controlling portion for controlling the display portion to provide preview display. The driver portion 25 converts data generated by the application portion 26 into a data format capable of being output by the electronic device 30. In addition, the driver portion 25 calls the preview display portion 24 that displays an image of data to be output by the electronic device 30. The application portion 26 has application software and generates data to be output by the electronic device 30.

The preview display controlling portion of the preview display portion 24 is activated by the driver portion 25 automatically or according to a preview instruction by a user from the inputting portion 21 with respect to data generated by the application portion 26, and causes the display portion to provide preview display of an image to be output by the electronic device 30 based on data of the limit function and the alternative function for the user account, that is stored in the storing portion 17 on the server 10. In this manner, the preview display portion 24 generates and displays the preview image of the output data based on limit function information and alternative function information transmitted from the server 10 or based on the changed output data that is transmitted from the server 10.

Here, when the client terminal 20 transmits only user account to the server 10 before transmitting the output data (in the case of the above-described (1a)), the preview display controlling portion of the preview display portion 24 receives data of the limit function and the alternative function for the user account that is stored in the storing portion 17 on the server 10 and read out by the function setting information changing portion 16, generates an image to be output by the electronic device 30 for the data generated by the application portion 26 based on the received alternative function, and causes the display portion to provide preview display.

In addition, the case where the client terminal 20 transmits function setting information (information showing setting contents for outputting) together with the user account to the server 10 (in the case of the above-described (1b)) includes the case where current setting contents of the output data that is being output to the electronic device 30 is setting contents that requires the limit function to the user, that is, the case where the current setting contents includes setting determined as the limit function. Thus, when function setting information is transmitted to the server 10, the preview display controlling portion of the preview display portion 24 receives function setting information that is changed by the function setting information changing portion 16 based on the limit function and the alternative function for the user account stored in the storing portion 17 for the data generated by the application portion 26, generates an image of the output data to be output by the electronic device 30 based on the changed function setting information that is received, and causes the display portion to provide preview display.

In addition, the case where the client terminal 20 transmits output data together with the user account to the server 10 (in the case of the above-described (1c)) includes the case where the output data for the electronic device 30 is data that requires the limit function to the user, that is, the case where the output data includes setting determined as the limit function. Thus, when the output data is transmitted to the server 10, the preview display controlling portion of the preview display portion 24 receives output data that is changed by the function setting information changing portion 16 based on the limit function and the alternative function for the user account stored in the storing portion 17 for the data generated by the application portion 26, generates an image to be output by the electronic device 30 based on the received output data, and causes the display portion to provide preview display.

In this manner, in the case of the above-described (1a), (1b) and (1c), the preview display portion 24 of the client terminal 20 generates and displays a preview image of output data (3a) based on the limit function information and the alternative function information transmitted from the above-described changed information transmitting portion, (3b) based on the changed function setting information transmitted from the above-described changed information transmitting portion and (3c) based on the changed output data transmitted from the above-described changed information transmitting portion, respectively.

This makes it possible, even when data being output or data desired to be output includes setting of the limit function and a user can not perform output as intended, for the user to confirm contents of the data to be output in advance before output in the client terminal 20. Accordingly, it is possible to prevent output unexpected by the user. The preview display portion 24, of course, may provide preview display even for output data that is not related to the limit function or may provide preview display only for output data, that runs into the limit function when providing preview display automatically.

The electronic device 30 is provided with an inputting portion 31, a main controlling portion 32, a communicating portion 33, a preview display portion 34 and an outputting portion 35, and receives output data generated by the client terminal 20 from the server 10 via the network 40 for outputting by the outputting portion 35 and causing the preview display portion 34 to provide preview display.

The inputting portion 31 receives input of a user account using the electronic device 30 and input that correlates a limit function, an alternative function, user account setting and group setting that are registered in the server 10, to each other. The main controlling portion 32 is provided with a CPU, a RAM as a working area, a ROM as a storage area of a processing program and the like, and performs control in the electronic device 30. The communicating portion 33 receives output data generated by the client terminal 20 from the server 10 via the network 40, or transmits a user account to the server 10. Note that, although data for registration that is input by the inputting portion 31 is transmitted to the server 10 via the communicating portion 33, registered in the storing portion 17 as appropriate, and used for the following judgment, it is also possible to carry out registration in the same way even from the server 10 or the client terminal 20 used by a user having administrator authority.

The preview display portion 34 has a display portion and a preview display controlling portion for performing preview control of the display portion. The preview display controlling portion, automatically or according to a preview instruction by a user from the inputting portion 31, causes the display portion to provide preview display of an image to be output by the electronic device 30 for the output data stored in the storing portion 17 and received via the communicating portion 33, that coincides with the user account input by the inputting portion 31. Here, the output data for the preview display is output data that is stored based on an output instruction from the client terminal 20, in which a limit function is rewritten into an alternative function as necessary. In this manner, the preview display portion 34 transmits information of the user account to the server 10 and receives from the server 10 output data capable of being output to the electronic device 30, that corresponds to the transmitted information of the user account and that is stored in the storing portion 17, to generate and display a preview image of the received output data.

Thus, it is possible for a user to confirm contents of the data to be output in advance before outputting the data in the main body of the electronic device 30 by inputting the user account in the electronic device 30, even when output data that has been already stored in the server 10 is output, if data desired to be output includes setting of the limit function and a user can not perform output as intended. The preview display portion 34, of course, may provide preview display even for output data that is not related to the limit function or may provide preview display only for output data that runs into the limit function when providing preview display automatically.

After providing preview display, output may be performed by the outputting portion 35 by receiving an execution operation from the inputting portion 31. The outputting portion 35 is only required to be configured to receive data generated by the client terminal 20 from the server 10 via the network 40 for outputting. For example, when the electronic device 30 is a printer, a printed sheet of paper is output. Here, the output data received from the server 10 is data subjected to changing processing by the function setting information changing portion 16 as necessary. Note that, the outputting portion 35 may be provided with an ASIC (Application Specific Integrated Circuit) for the control. Moreover, it may be configured such that the ASIC is provided as the main controlling portion 32.

Further, although an example has been taken that output data from the client terminal 20 is temporarily stored in the server 10 and output by the electronic device 30 triggered by input of a user account from the electronic device 30, it may be configured such that the server 10 directly transmits the output data that is rewritten as necessary to the electronic device 30 immediately when an execution operation is performed by the inputting portion 21 of the client terminal 20. In this manner, the server 10 may output to the electronic device 30 output data that is stored in the storing portion 17 and is available to be output to the electronic device 30 as it is soon after the storage, that is, soon after an output instruction is given from the client terminal 20. Moreover, with such a configuration, a user has already confirmed output contents by the preview display of the preview display portion 24, and therefore the electronic device 30 that received the output data is only required to output the output data automatically without providing preview display.

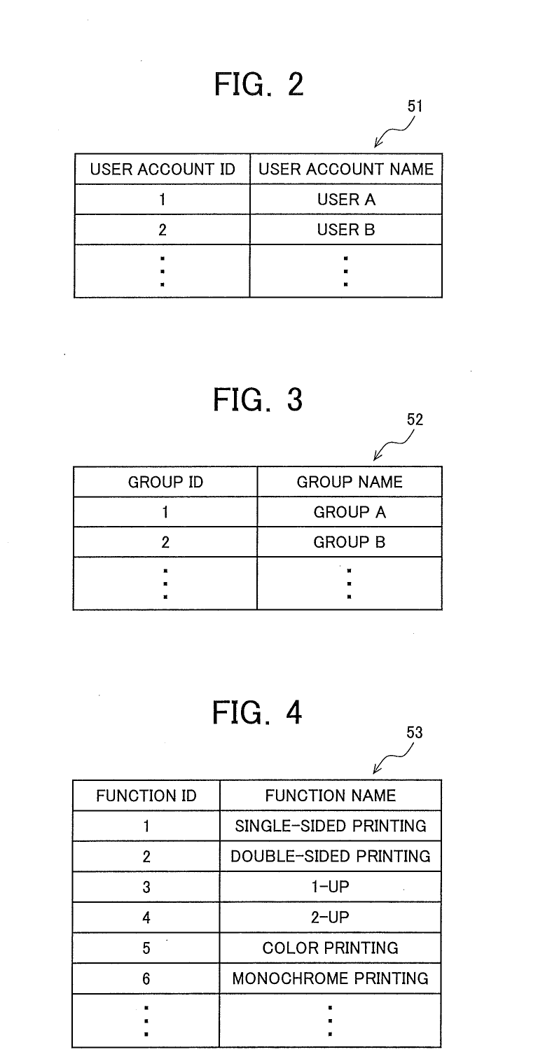

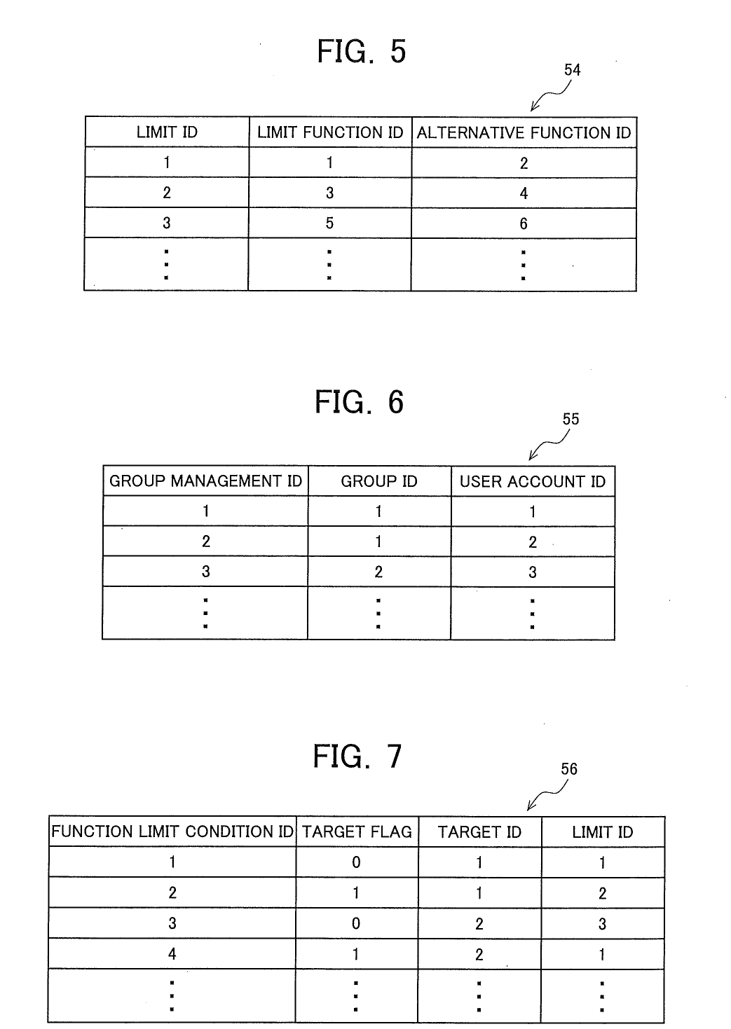

Next, processing in the electronic device controlling system 100 according to the present embodiment will be described specifically taking a case where the electronic device 30 is a printer as an example. FIGS. 2 to 7 are views showing an example of data that correlates limit functions, alternative functions, user account setting and group setting which are stored in the server of the electronic device controlling system according to the present embodiment, to each other. Here, FIGS. 2, 3, 4, 5, 6 and 7 are views showing examples of a user table, a group user table, a function table, a limit/alternative table, a group management table and a function limit management table, that are stored in the storing portion 17, respectively, and these tables are stored being correlated to each other in the storing portion 17 like the following example. Note that, a correlating method and the format of tables are not limited to ones illustrated here.

A user table 51 is a table registering user accounts, in which user account IDs and user account names are stored. For example, in the first row (first record) on the user table 51, the user account ID is “1” and the user account name is “user A”. A group table 52 is a table registering groups, in which group IDs and group names are stored. For example, in the first row of the group table 52, the group ID is “1” and the group name is “group A”.

A function table 53 is a table registering various functions, in which function IDs and function names are stored. For example, in the first row of the function table 53, the function ID is “1” and the function name is “single-sided printing”. Other function names include double-sided printing, 1-UP (printing one page on one sheet of paper), 2-UP (printing two pages on one sheet of paper), color printing, monochrome printing and the like.

A limit/alternative function table 54 is a table registering limit functions and alternative functions, in which limit IDs, limit functions IDs and alternative function IDs are stored. For example, in the first row, the limit ID is “1” and the limit function ID is “1”, which shows “single-sided printing” from the function table 53, and the alternative function ID is “2”, which shows “double-sided printing” from the function table 53.

A group management table 55 is a table connecting user accounts to groups, in which group management IDs, group IDs and user account ID names are stored. For example, in the first row, the group management ID is “1” and the group ID is “1”, which shows “group A” from the group table 52, and the user account ID is “1”, which shows “user A” from the user table 51.

A function limit management table 56 is a table connecting limit functions and alternative functions, and user accounts or groups, in which function limit condition IDs, target flags, target IDs and limit IDs are stored. The target flag represents whether a limiting target is a group or a user account, and “0” shows that the target is a user account and “1” shows that the target is a group. The target ID corresponds to the target flag, and the user account target “0” shows a user account ID and the group target “1” shows a group ID. For example, in the first row, the function limit condition ID is “1” and the target flag is “0”, that is, “user account target”, and the target ID is “1”, which shows “user A” from the user table 51. Further, in the first row, the limit ID is “1”, which shows that the limit function ID is “1” and the alternative function ID is “2” from the limit/alternative function table 54, that is, the limit function is “single-sided printing” and the alternative function is “double-sided printing” from the function table 53.

For example, the following is a case where the user A is searched and where group management is also performed.

When the user account ID “1” is input, it is found that the user account name is “user A” from the user table 51, and the group ID is “1” from the group management table 55, that is, belonging to “group A” from the group table 52. Thus, the target flag “0” and the target ID “1”, that is, conditions of “user A” (personal conditions of the user A) and the target flag “1” and the target ID “1”, that is, conditions of “group A” (conditions of the group to which the user A belongs) in the function limit management table 56 are extracted.

From the function limit management table 56, the function limit condition IDs “1” and “2” are applied. The limit IDs are and “2”, respectively. From the limit/alternative function table 54, the combination of the limit function ID “1” and the alternative function ID “2”, and the combination of the limit function ID “3” and the alternative function ID “4” are applied. Each of which shows the alternative function “double-sided printing” for the limit function “single-sided printing” and the alternative function “2-UP” for the limit function “1-UP” from the function table 53.

That is, it is found that, when the user A performs output, the setting of “single-sided printing” is changed into “double-sided printing” and the setting of “1-UP” is changed into “2-UP”.

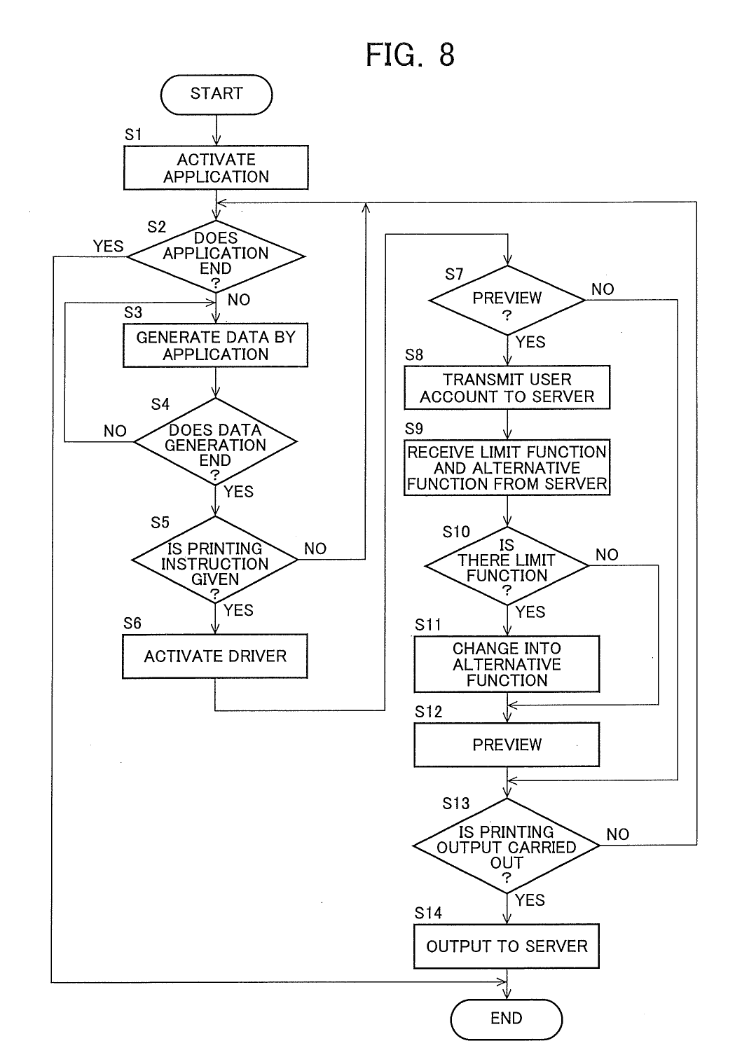

Next, exemplary processing in each device of the electronic device controlling system 100 according to the present embodiment will be described with reference to FIGS. 8 to 10. FIGS. 8, 9 and 10 are flowcharts for explaining operations on a client terminal, operations on a server and operations on an electronic device in the electronic device controlling system of FIG. 1, respectively.

First, exemplary operations on the client terminal 20 will be described with reference to FIG. 8.

When a user performs an activating operation from the inputting portion 21, the main controlling portion 22 activates the application portion 26 on the client terminal 20 (step S1). The main controlling portion 22 judges whether or not an instruction to end the application is given from the inputting portion 21 (step S2), and when the instruction is given, ends processing. On the other hand, at a stage where no end instruction is given (in the case of NO at step S2), the main controlling portion 22 continues the activation state of the application and the application portion 26 generates data according to the instructions from the inputting portion 21 (step S3).

The main controlling portion 22 then judges whether or not an instruction to end data generation is given from the inputting portion 21 (step S4), and until the instruction to end data generation is given (until the result becomes YES), causes the application portion 26 to continue the data generation at step S3. At a stage where the result becomes YES at step S4, the main controlling portion 22 judges whether or not a printing instruction is given from the inputting portion 21 (step S5). In the case of NO at step S5, the flow goes back to step S2. Here, the instruction to end data generation relating to step S4 is only required to be an instruction showing reaching a stage to output, and an output instruction (printing instruction relating to step S5 in this example) is applicable, so that step S4 may be omitted.

On the other hand, in the case of YES at step S5, the main controlling portion 22 activates the driver portion 25 (step S6). The main controlling portion 22 judges whether or not an instruction of a preview display is received from the inputting portion 21 (step S7), and the flow goes to step S13 described below in the case of NO.

In the case of YES at step S7, the main controlling portion 22 activates the preview display portion 24 and transmits a user account from the communicating portion 23 to the server 10 via the network 40 (step S8). The user account to be transmitted has been already input from the inputting portion 21 when logging into the client terminal 20, or in an environment where the client terminal 20 is used only by a specific user, is obtained by reading out a user account of a user allocated to the client terminal 20 in advance.

The server 10 receives the user account by the communicating portion 13 and searches by the searching portion 15 whether or not information of a limit function to the corresponding user account and an alternative function therefor exists. When the information exists, the searching portion 15 reads out the information of the limit function and the alternative function as the search result, and the function setting information changing portion 16 transmits the search result from the communicating portion 13 to the client terminal 20 via the network 40. When the information does not exist, the server 10 transmits the search result showing that the information does not exist in the same way. The client terminal 20 receives the search result by the communicating portion 23 (step S9). The main controlling portion 22 judges whether or not there is a limit function to the corresponding user account in the received search result (step S10), and when there is a limit function (in the case of YES), a preview image is generated by the preview display portion 24 in accordance with setting by which the limit function is changed into the alternative function received as the search result (step S11). The preview display portion 24 then displays the preview image (step S12).

Thereafter, the main controlling portion 22 judges whether or not a printing instruction is received from the inputting portion 21 (step S13), and when carrying out printing output (in the case of YES), generates output data by the driver portion 25 and transmits the output data from the communicating portion 23 to the server 10 via the network 40 (step S14). On the other hand, in the case of NO at step S13, the flow goes back to step S2.

Although an example where only a user account is transmitted at step S8 was described with reference to FIG. 8, it may be configured such that output data to be printed is also further transmitted at step S8 as described above as another exemplary processing. For example, output data such as a printing job may include a user account. This output data also includes function setting information. In such a case, processing for receiving output data after changing into the alternative function from the server 10 and generating/displaying a preview image may be performed instead of steps S9 to S12.

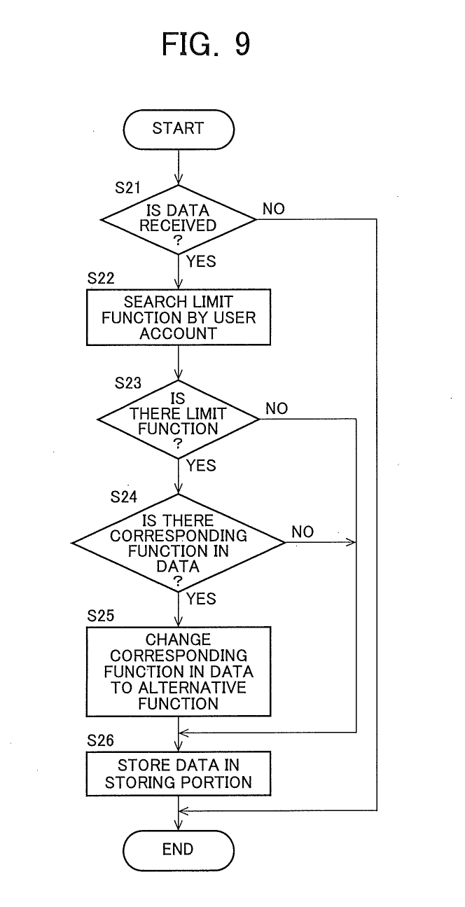

Next, exemplary operations in the server 10 in such an example, that is, exemplary operations when output data is received from the client terminal 20 on the server 10 will be described with reference to FIG. 9.

The main controlling portion 12 of the server 10 judges whether or not output data subjected to output processing in the electronic device 30 is received by the communicating portion 13 of the server 10 from the client terminal 20 (step S21). When no output data is received (in the case of NO), the processing ends, and when output data is received (in the case of YES), the searching portion 15 searches a limit function of the corresponding user account (step S22). The searching portion 15 judges whether or not the limit function of the corresponding user account exists as a result of the search (step S23).

When the function limit of the corresponding user account exists (in the case of YES at step S23), it is analyzed/judged whether or not (function setting information of) the received output data includes the limit function (step S24). When the corresponding function exists (in the case of YES at step S24), the function setting information changing portion 16 changes the corresponding limit function in the received output data into the alternative function (step S25). The main controlling portion 22 stores the output data changed at step S25 in the storing portion 17 (step S26). Alternatively, when there is no limit function (in the case of NO at step S23) or when there is no corresponding limit function in the output data (in the case of NO at step S24), the output data received from the client terminal 20 is stored in the storing portion 17 as it is.

Moreover, in an embodiment that function setting information is transmitted instead of transmitting output data such as a printing job, it may be configured such that function setting information after changing into the alternative function is obtained from the server 10, and based on which, setting of the electronic device 30 is changed to generate/display a preview image instead of steps S9 to S12, and the detailed description of which will be omitted.

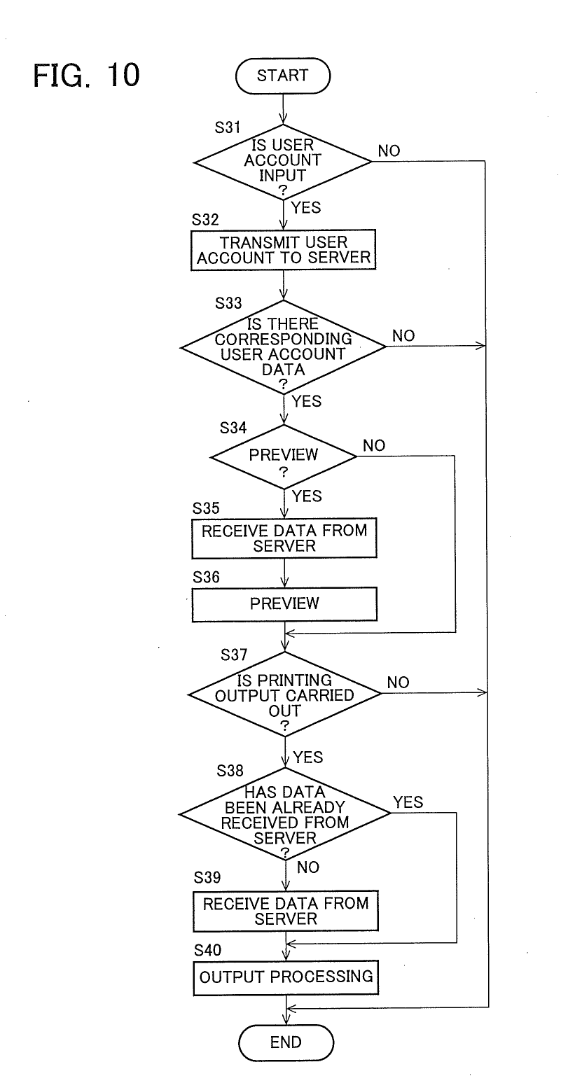

Next, exemplary operations when output data stored in the server 10 is output on the electronic device 30 will be described with reference to FIG. 10.

The main controlling portion 32 of the electronic device 30 judges whether or not a user account is input by the inputting portion 31 (step S31). The input may be performed by inserting an ID card/reading out data. When no user account is input (in the case of NO), the processing ends, and when a user account is input (in the case of YES), the main controlling portion 32 transmits the user account from the communicating portion 33 to the server 10 via the network 40 (step S32).

At the server 10, the communicating portion 13 receives the user account, the searching portion 15 searches if output data for the corresponding user account exists in the storing portion 17, and the communicating portion 13 transmits the search result for the corresponding user account to the electronic device 30 via the network 40. At the electronic device 30, the main controlling portion 32 receives the search result via the communicating portion 33 and judges whether or not the search result shows that there is output data for the corresponding user account (step S33). When there is no output data (in the case of NO at step S33), the processing ends.

On the other hand, when the corresponding output data exists (in the case of YES at step S33), the main controlling portion 32 judges whether or not to provide preview display based on a user operation, previous setting and the like (step S34). When giving preview display (in the case of YES at step S34), the main controlling portion 32 receives by the communicating portion 33 the output data (output data rewritten by the function setting information changing portion 16 as necessary) from the server 10 via the network 40 (step S35). Then, the main controlling portion 32 activates the preview display portion 34 and the preview display portion 34 generates and displays a preview image of the received output data (step S36).

Subsequent to step S36, when preview display is not given (in the case of NO at step S34), the main controlling portion 32 judges whether or not a printing instruction is input from the inputting portion 31 (step S37), and when not carrying out (in the case of NO), the processing ends.

On the other hand, when carrying out printing output (in the case of YES at step S37), the main controlling portion 32 judges whether or not the output data has been received from the server 10 (step S38). When the output data has been received (in the case of YES at step S38), the main controlling portion 32 causes the outputting portion 35 to perform output processing as it is (step S40). When the output data has not been received from the server 10 (in the case of NO at step S38), the main controlling portion 32 requests, by the communicating portion 33, to transmit the output data and receives the output data from the communicating portion 13 of the server 10 via the network 40 (step S39) for performing output processing (step S40).

As described above, according to the electronic device controlling system of the present invention, account information such as user account setting and group setting, function limit information and alternative function information is stored in the server by being corresponded to each other, so that it becomes possible to change a limit function into an alternative function therefor in accordance with a user account of a user who uses the client terminal or the electronic device and to manage limit of functions in an integrated fashion for each account information. That is, policy setting of the function limit and the alternative function for the user account or the user account and group setting is made to the server, and the policy setting makes it possible to control the function limit, for example, such as prohibiting double-sided printing.

Further, according to the electronic device controlling system of the present invention, when a user operates the client terminal to output data by the electronic device or when a user directly operates the electronic device to output data stored in the server, it becomes possible to confirm contents of the data to be output in advance before output. That is, the preview function in the client terminal or the electronic device makes it possible to confirm whether or not the result with the function limited brings output as desired before ending the output operation in the electronic device. Accordingly, it is possible to prevent that undesired output is carried out due to the function limit, thus making it possible to prevent wasteful output by the erroneous operation by the user.

In addition, although a general printer such as an electrophotographic printer is taken as an example of the electronic device and the installation site of the printer is not mentioned, the electrophotographic printer may be installed in an external facility, for example, such as a shop making photograph printing, bound books and the like. More specifically, such an example is taken that the network 40 is the Internet and the electronic device 30 is the kiosk terminal of a convenience store or an electrophotographic printer of a DPE (Development, Printing, Enlargement) shop in FIG. 1. In such a usage environment, a user can request a photographic printing online from the website of the shop using the client terminal 20 such as a personal digital assistance or a household PC. In particular, the user can obtain the photograph having image quality and size corresponding to the user account, that is, the photograph having image quality and size in accordance with limit function information and alternative function information set on the server 10 in advance in accordance with the user account from the installation site of the electrophotographic printer or by delivery from there. In addition, the user can view the photograph having such image quality and size in advance on the client terminal 20, so that the user can determine whether or not to actually send a request after viewing.

Moreover, such an example has been taken that information stored by being correlated to limit function information and alternative function information in the server 10 is user account information, or user account information and group setting information, the information may be user type information showing a user type instead. That is, in the server 10, it is only required that user information defined as any one of user account information, user account information and group setting information, and user type information is stored by being correlated to limit function information and alternative function information in the server 10.

The user type information is information for specifying a user by a user type in the server 10. A table in which user type information and available functions (limit function information and alternative function information) are correlated is stored in the server 10. Moreover, the client terminal 20 transmits the user type information to the server 10 based on input by a user operation, insertion of an IC card and the like, and obtains information of available output functions (printing function and the like) in accordance with the user type from the server 10, and preview display based on which becomes possible. Therefore, it is only required to manage only available functions corresponding to the user type on the server 10 and it is not necessary to manage all users individually, so that loads on the server 10 and operations of an administrator of the server 10 are simplified.

Examples of the user type information include a numerical number showing a rank of a user, described on a membership card of photograph printing online and the like. Even when the membership card is not an IC card, the rank can be read by a scanner if the information of the rank is printed on the surface. The server 10 may refer to a table in which a rank of a user is described with an encoded numerical number to decode the number on the server 10, judge the rank, impose a function limit and transmit the alternative function therefor to the client terminal 20 side. In addition, examples of the rank of a user include a highly-charged user, a normally-charged user, a free trial user and the like. As an example of a method for imposing a limit, by transmitting user type information to the server 10, color printing limit, image quality printing limit and the like for advertisement data in accordance with the rank of a user (for example, past result of purchase) are also usable.

In addition, in the exemplary system configuration mainly described in FIG. 1, the server 10 may decentralize some of its functions. More preferably, the server 10 may be comprised of an authenticating server having a limit information storing portion and a searching portion and a data processing management server connected to the authenticating server and having a changed information transmitting portion. Describing a case where data output is printing, the authenticating function and the printing management function may not be executed by the same server but executed by individual server with decentralized functions.

In addition, although the electronic device controlling system in each exemplary configuration described above (hereinafter referred to as a first system) is a system in which the client terminal 20 is essential, a system comprised of the server 10 and the electronic device 30 without having the client terminal 20 is also able to be employed in the system of FIG. 1 in the present invention. The electronic device in the electronic device controlling system with such a configuration (hereinafter referred to as a second system) is basically a device capable of outputting data by a user operation from an operation portion provided in a main body. In this manner, the second system is a system that the client terminal 20 is excluded from the electronic device controlling system 100 of FIG. 1, and is briefly described with reference to FIG. 1 in the same way. Moreover, the second system may also have the server with functions decentralized in the same way as the first system.

The server 10 in the second system is also provided with the above-described limit information storing portion which can be illustrated as the storing portion 17 and the limit function setting portion 14 and the like, and the searching portion 15. Further, the electronic device 30 in the second system is provided with a device-side information transmitting portion for transmitting (Ia) the user information, (Ib) the user information and function setting information used in the electronic device or (Ic) output data including the user information and the function setting information to the server 10. The device-side information transmitting portion can be illustrated mainly by the main controlling portion 32 and the communicating portion 33. The searching portion 15 of the server 10 searches whether or not user information transmitted from the above-described device-side information transmitting portion is stored in the above-described limit information storing portion, and when the user information is stored, reads out limit function information and alternative function information correlated to the user information.

The server 10 in the second system is provided with a changed information transmitting portion which can be illustrated mainly by the function setting information changing portion 16 in the same way as the first system. However, the transmission destination of information by the changed information transmitting portion in the second system is, of course, not the client terminal but the electronic device 30. That is, corresponding to the above-described (Ia), (Ib) or (Ic), respectively, the changed information transmitting portion in the second system (IIa) transmits the limit function information and the alternative function information read out by the searching portion 15 to the electronic device 30, (IIb) changes a part of the function setting information, that corresponds to the limit function information, into the alternative function information, based on the limit function information and the alternative function information read out by the searching portion 15 and transmits the changed function setting information to the electronic device 30 or (IIc) changes a part of the function setting information in the output data, that corresponds to the limit function information, into the alternative function information based on the limit function information and the alternative function information read out by the searching portion 15 and transmits the changed output data to the electronic device 30. In addition, the electronic device 30 is provided with the preview display portion 34. However, as shown from the contents of transmission from the server 10, the preview display portion 34 in the second system generates and displays a preview image of output data (IIIa) based on the limit function information and the transmitted alternative function information, (IIIb) based on the transmitted changed function setting information or (IIIc) based on the transmitted changed output data, corresponding to the above-described (Ia), (Ib) or (Ic), respectively.

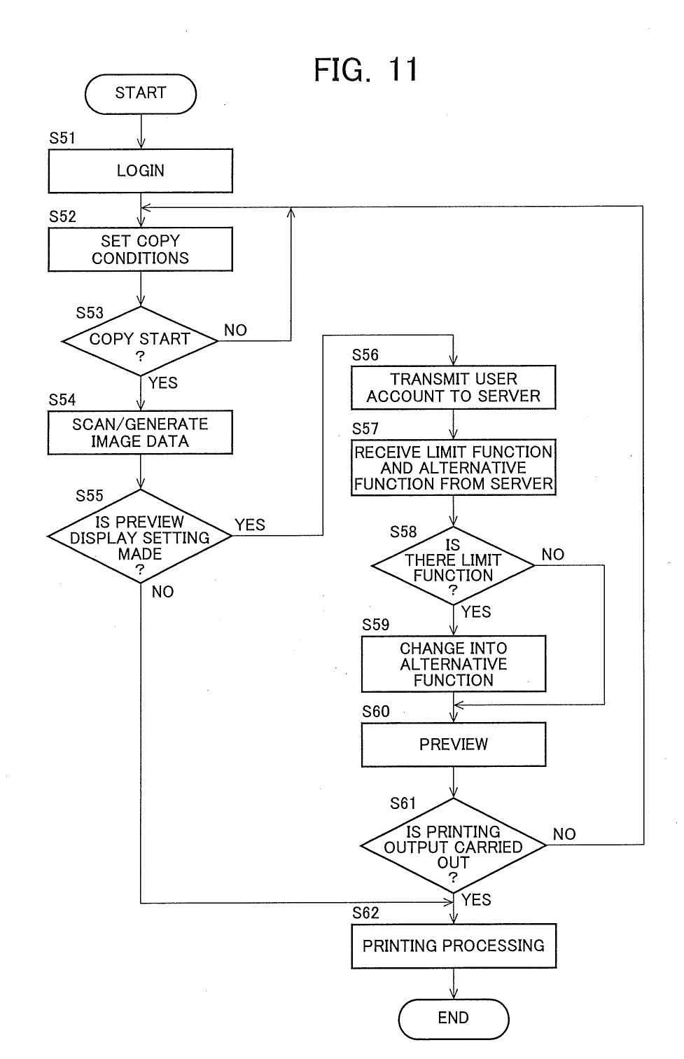

An example of processing in each device of the second system will be described with reference to FIG. 11. FIG. 11 is a flowchart for explaining operations on the electronic device in the second system. Description will be given below taking a copier as an example of the electronic device 30. The copier executes printing of image data that is optically read as output processing.

First, in the electronic device 30 serving as the copier, when a user inputs login information from the inputting portion 31, the main controlling portion 32 executes login processing (step S51). While the main controlling portion 32 receives setting of copy conditions from the inputting portion 31 and executes setting (step S52), the main controlling portion 32 waits for pressing a copy start key in the inputting portion 31 (step S53). At a stage where the copy start key is pressed, based on the control by the main controlling portion 32, scanning is started and image data is generated as a result of the scanning, and the scanned image data thus generated is saved (step S54).

The main controlling portion 32 judges whether or not setting of preview display (including default setting) from the inputting portion 31 is made in advance (step S55), and in the case of NO, the flow goes to step S62 described below to execute printing processing.

In the case of YES at step S55, the main controlling portion 32 activates the preview display portion 34 and transmits a user account from the communicating portion 33 to the server 10 via the network 40 (step S56). The user account to be transmitted may be already input from the inputting portion 21 such as at the time of login at step S51, or may be input by urging a user to input after step S55.

The server 10 receives the user account by the communicating portion 13 and searches by the searching portion 15 whether or not information of a limit function and an alternative function therefor for the corresponding user account exists. When the information exists, the searching portion 15 reads out the information of the limit function and the alternative function as the search result, and the function setting information changing portion 16 transmits the search result from the communicating portion 13 to the electronic device 30 via the network 40. When the information does not exist, the server 10 transmits the search result showing that the information does not exist in the same way. The electronic device 30 receives the search result by the communicating portion 33 (step S57). Note that, when authentication of usage itself of the electronic device 30 by a user is also carried out by the server 10, the authentication may be carried out by communication with the server 10 at the time of login processing at step S51, where processing at steps S56 and S57 are desirably executed.

The main controlling portion 32 judges whether or not there is a limit function to the corresponding user account in the received search result (step S58), and when there is a limit function (in the case of YES), the preview display portion 34 generates a preview image from the scanned image data in accordance with setting by which the limit function is changed into the alternative function received as the search result (step S59). The preview display portion 34 then displays the preview image (step S60).

The main controlling portion 32 then judges whether or not a printing instruction from the inputting portion 31 is received (step S61), and when carrying out printing output (in the case of YES), output data (printing data) is generated by the outputting portion 35 and printing processing is executed (step S62). On the other hand, in the case of NO at step S61, the flow goes back to step S52, and the user may operate again by resetting copy conditions and give a printing instruction at a stage where preview of desired image quality can be confirmed.

Note that, it may be configured such that the resetting of copy conditions is received at a stage where preview display is provided at step S60, and the scanned image data saved at step S54 is reset and thereafter processed considering the limit function and the alternative function saved in the same way to generate a preview image from the processed image data to be confirmed by the user. Thereby, it is not necessary to carry out scanning again such as by going back to step S52.

In addition, although the example where only user account is transmitted at step S56 has been described in FIG. 11, it may be configured such that, output data to be printed is also further transmitted at step S56 in the same way as the processing in the first system, illustrated in FIG. 9. For example, data of a printing job may include a user account. In such a case, processing for receiving output data after changing into the alternative function from the server 10 and generating/displaying a preview image may be performed instead of steps S57 to S60. Moreover, such processing may be performed that function setting information (information showing copy conditions in this example) is transmitted instead of transmitting data of a printing job, and, instead of steps S57 to S60, function setting information after it was changed into the alternative function is obtained from the server 10, and setting of the electronic device 30 is changed based on the obtained information to generate/display a preview image.

In this manner, according to the second system of the present invention, a limiting function (limit function) of the electronic device and an alternative function therefor are able to be managed in an integrated fashion on the server side for each account information or for each user type, and when a user directly operates the electronic device to output data by the electronic device, the user is allowed to confirm contents of the data to be output in advance before output. For example, when an original document is read by a copier to generate image data and condition setting is made to print the image data in color, if color limit is imposed in the server, printing can be also executed with printing setting changed into monochrome.

Note that, as an application example of the second system, various examples described above for explaining the first system even including the client terminal 20 are applicable in the same way. However, an embodiment that output data stored in the server 10 is read out from the electronic device does not particularly need to be applied.

While the electronic device controlling systems (the first system and the second system) of the present invention and each device in these systems has mainly described, the present invention also comes into effect as an electronic device controlling method in the electronic device controlling systems having such a connection configuration as the flow of control in each device has been illustrated.

The electronic device controlling method in the first system has a limit information storing step, a terminal-side information transmitting step, a searching step, a changed information transmitting step and a preview display step, which will be described below.

Describing each step simply, the limit information storing step is a step in which the server stores user information, limit function information showing a function the usage of which is limited among functions of the electronic device, and alternative function information showing a function used as an alternative for the limiting function by correlating the above information to each other. The terminal-side information transmitting step is a step in which the client terminal transmits (1a) the user information, (1b) the user information and function setting information used in the electronic device or (1c) output data including the user information and function setting information to the server.

The searching step is a step in which the server searches whether or not the user information transmitted at the terminal-side information transmitting step is stored at the limit information storing step, and when the user information is stored, reads out the limit function information and the alternative function information each of which is correlated to the user information. The changed information transmitting step is a step in which the server (2a) transmits the limit function information and the alternative function information read out at the searching step to the client terminal, (2b) changes a part of the function setting information, that corresponds to the limit function information, into the alternative function information, based on the limit function information and the alternative function information read out at the searching step and transmits the changed function setting information to the client terminal or (2c) changes a part of the function setting information in the output data, that corresponds to the limit function information, into the alternative function information, based on the limit function information and the alternative function information read out at the searching step and transmits the changed output data to the client terminal.

The preview display step is a step in which the client terminal generates and displays a preview image of output data (3a) based on the limit function information and the alternative function information transmitted at the changed information transmitting step, (3b) based on the changed function setting information transmitted at the changed information transmitting step or (3c) based on the changed output data transmitted at the changed information transmitting step. Note that, descriptions about applications of the electronic device controlling method of the present invention will be omitted, because various examples described above for explaining the electronic device controlling system (the first system) can be applied similarly to the applications.

The electronic device controlling method in the second system includes a limit information storing step, a device-side information transmitting step, a searching step, a changed information transmitting step and a preview display step, which will be described below.

The limit information storing step is a step in which the server stores user information, limit function information showing a function the usage of which is limited among functions of the electronic device, and alternative function information showing a function used as an alternative for the limiting function by correlating the above information to each other. The device-side information transmitting step is a step in which the electronic device transmits (Ia) the user information, (Ib) the user information and function setting information used in the electronic device or (Ic) output data including the user information and function setting information used in the electronic device to the server. The searching step is a step in which the server searches whether or not the user information transmitted at the device-side information transmitting step is stored at the limit information storing step, and when the user information is stored, reads out the limit function information and the alternative function information each of which is correlated to the user information.

The changed information transmitting step is a step in which the server (IIa) transmits the limit function information and the alternative function information read out at the searching step to the electronic device, (IIb) changes a part of the function setting information, that corresponds to the limit function information, into the alternative function information, based on the limit function information and the alternative function information read out at the searching step and transmits changed function setting information to the electronic device or (IIc) changes a part of the function setting information in the output data, that corresponds to the limit function information, into the alternative function information, based on the limit function information and the alternative function information read out at the searching step and transmits changed output data to the electronic device. The preview display step is a step in which the electronic device generates and displays a preview image of output data (IIIa) based on the limit function information and the alternative function information transmitted at the changed information transmitting step, (IIIb) based on the changed function setting information transmitted at the changed information transmitting step or (IIIc) based on the changed output data transmitted at the changed information transmitting step. Note that, an application of the electronic device controlling method in the second system is as described above for the second system, so that description of which will be omitted.

In addition, as described as a program in the server 10, the client terminal 20 and the electronic device 30, the present invention also comes into effect as a program causing a computer to function as each portion in each device of the first system constituting the above-described embodiment or a recording medium having the program recorded therein. Further, in the same way, the present invention also comes into effect as a program causing a computer to function as each portion in each device of the second system comprised of the server and the electronic device or a recording medium having the program recorded therein. These programs are also referred to as programs for causing a computer (main controlling portion) of each device to execute the above-described electronic device controlling method.

The functions of the present invention can be realized when the programs recorded in the recording medium and the programs received via the network are stored in a memory provided for a corresponding device or a storing device and these programs are executed by a computer (main controlling portion). For example, like the program for performing control in the driver portion 25 and the preview display portion 24 in FIG. 1 or the preview display portion 34 of FIG. 1, by incorporating the program on the client terminal or the electronic device as a driver program, it is possible to provide preview display from the driver program. In addition, the above-described programs may be programs in which the functions of the present invention described above are realized by the programs that process in cooperation with an operating system, other application program or the like based on instructions of the programs.

Note that, the above-described recording medium may be a recording medium of any form of a disk type (for example, a magnetic disk and an optical disk), a card type (for example, a memory card and an optical card), a semiconductor memory type (for example, a ROM and a non-volatile memory), a tape type (for example, a magnetic tape and a cassette tape) and the like. Moreover, reception via the network refers to reception of the program recorded in a storing device of an external server or the like.

In this manner, reduction of costs, and portability and multi-purpose property can be improved by programming the functions of the present invention and distributing the programmed functions.

According to the present invention, in an electronic device controlling system having a server and an electronic device capable of outputting data connected to a network, a limiting function (limit function) of the electronic device and an alternative function therefor are able to be managed in an integrated fashion on the server side for each account information or for each user type, and the user is allowed to confirm contents of the data to be output in advance before output when a user operates the client terminal to output data by the electronic device, when a user directly operates the electronic device to output data stored in the server, or when a user directly operates the electronic device to output data in the electronic device.

1. An electronic device controlling system in which a server, a client terminal and an electronic device capable of outputting data via the server in response to an instruction from the client terminal are connected to a network, wherein
the server comprises a limit information storing portion for storing user information, limit function information showing a function usage of which is limited among functions of the electronic device, and alternative function information showing a function used as an alternative for the limiting function by correlating the above information to each other,
the client terminal comprises a terminal-side information transmitting portion for transmitting the user information to the server,
the server further comprises a searching portion for searching whether or not the user information transmitted from the terminal-side information transmitting portion is stored in the limit information storing portion, and reading out the limit function information and the alternative function information each of which is correlated to the user information when the user information is stored, and a changed information transmitting portion for transmitting the limit function information and the alternative function information read out by the searching portion to the client terminal, and
the client terminal further comprises a preview display portion for generating and displaying a preview image of output data based on the limit function information and the alternative function information transmitted from the changed information transmitting portion.

2. An electronic device controlling system in which a server, a client terminal and an electronic device capable of outputting data via the server in response to an instruction from the client terminal are connected to a network, wherein
the server comprises a limit information storing portion for storing user information, limit function information showing a function usage of which is limited among functions of the electronic device, and alternative function information showing a function used as an alternative for the limiting function by correlating the above information to each other,
the client terminal comprises a terminal-side information transmitting portion for transmitting the user information and function setting information used in the electronic device to the server,
the server further comprises a searching portion for searching whether or not the user information transmitted from the terminal-side information transmitting portion is stored in the limit information storing portion, and reading out the limit function information and the alternative function information each of which is correlated to the user information when the user information is stored, and a changed information transmitting portion for changing a part of the function setting information, that corresponds to the limit function information, into the alternative function information based on the limit function information and the alternative function information read out by the searching portion, and transmitting the changed function setting information to the client terminal, and
the client terminal further comprises a preview display portion for generating and displaying a preview image of output data based on the changed function setting information transmitted from the changed information transmitting portion.

3. An electronic device controlling system in which a server, a client terminal and an electronic device capable of outputting data via the server in response to an instruction from the client terminal are connected to a network, wherein
the server comprises a limit information storing portion for storing user information, limit function information showing a function usage of which is limited among functions of the electronic device, and alternative function information showing a function used as an alternative for the limiting function by correlating the above information to each other,
the client terminal comprises a terminal-side information transmitting portion for transmitting output data including the user information and function setting information used in the electronic device to the server,
the server further comprises a searching portion for searching whether or not the user information transmitted from the terminal-side information transmitting portion is stored in the limit information storing portion, and reading out the limit function information and the alternative function information each of which is correlated to the user information when the user information is stored, and a changed information transmitting portion for changing a part of the function setting information in the output data, that corresponds to the limit function information, into the alternative function information based on the limit function information and the alternative function information read out by the searching portion, and transmitting the changed output data to the client terminal, and
the client terminal further comprises a preview display portion for generating and displaying a preview image of output data based on the changed output data transmitted from the changed information transmitting portion.

4. An electronic device controlling system in which a server and an electronic device capable of outputting data are connected to a network, wherein
the server comprises a limit information storing portion for storing user information, limit function information showing a function usage of which is limited among functions of the electronic device, and alternative function information showing a function used as an alternative for the limiting function by correlating the above information to each other,
the electronic device comprises a device-side information transmitting portion for transmitting the user information to the server,
the server further comprises a searching portion for searching whether or not the user information transmitted from the device-side information transmitting portion is stored in the limit information storing portion, and reading out the limit function information and the alternative function information each of which is correlated to the user information when the user information is stored, and a changed information transmitting portion for transmitting the limit function information and the alternative function information read out by the searching portion to the electronic device, and
the electronic device further comprises a preview display portion for generating and displaying a preview image of output data based on the limit function information and the alternative function information transmitted from the changed information transmitting portion.

5. An electronic device controlling system in which a server and an electronic device capable of outputting data are connected to a network, wherein
the server comprises a limit information storing portion for storing user information, limit function information showing a function usage of which is limited among functions of the electronic device, and alternative function information showing a function used as an alternative for the limiting function by correlating the above information to each other,
the electronic device comprises a device-side information transmitting portion for transmitting the user information and function setting information used in the electronic device to the server,
the server further comprises a searching portion for searching whether or not the user information transmitted from the device-side information transmitting portion is stored in the limit information storing portion, and reading out the limit function information and the alternative function information each of which is correlated to the user information when the user information is stored, and a changed information transmitting portion for changing a part of the function setting information, that corresponds to the limit function information, into the alternative function information, based on the limit function information and the alternative function information read out by the searching portion, and transmitting the changed function setting information to the electronic device, and
the electronic device further comprises a preview display portion for generating and displaying a preview image of output data based on the changed function setting information transmitted from the changed information transmitting portion.

6. An electronic device controlling system in which a server and an electronic device capable of outputting data are connected to a network, wherein
the server comprises a limit information storing portion for storing user information, limit function information showing a function usage of which is limited among functions of the electronic device, and alternative function information showing a function used as an alternative for the limiting function by correlating the above information to each other,
the electronic device comprises a device-side information transmitting portion for transmitting output data including the user information and function setting information used in the electronic device to the server,
the server further comprises a searching portion for searching whether or not the user information transmitted from the device-side information transmitting portion is stored in the limit information storing portion, and reading out the limit function information and the alternative function information each of which is correlated to the user information when the user information is stored, and a changed information transmitting portion for changing a part of the function setting information in the output data, that corresponds to the limit function information, into the alternative function information, based on the limit function information and the alternative function information read out by the searching portion, and transmitting the changed output data to the electronic device, and
the electronic device further comprises a preview display portion for generating and displaying a preview image of output data based on the changed output data transmitted from the changed information transmitting portion.

7. An electronic device controlling method in an electronic device controlling system in which a server, a client terminal and an electronic device capable of outputting data via the server in response to an instruction from the client terminal are connected to a network, comprising:
a limit information storing step in which the server stores user information, limit function information showing a function usage of which is limited among functions of the electronic device, and alternative function information showing a function used as an alternative for the limiting function by correlating the above information to each other;
a terminal-side information transmitting step in which the client terminal transmits the user information to the server;
a searching step in which the server searches whether or not the user information transmitted at the terminal-side information transmitting step is stored at the limit information storing step, and reads out the limit function information and the alternative function information each of which is correlated to the user information when the user information is stored;
a changed information transmitting step in which the server transmits the limit function information and the alternative function information read out at the searching step to the client terminal; and
a preview display step in which the client terminal generates and displays a preview image of output data based on the limit function information and the alternative function information transmitted at the changed information transmitting step.

8. An electronic device controlling method in an electronic device controlling system in which a server, a client terminal and an electronic device capable of outputting data via the server in response to an instruction from the client terminal are connected to a network, comprising:
limit information storing step in which the server stores user information, limit function information showing a function usage of which is limited among functions of the electronic device, and alternative function information showing a function used as an alternative for the limiting function by correlating the above information to each other;
a terminal-side information transmitting step in which the client terminal transmits the user information and function setting information used in the electronic device to the server;
a searching step in which the server searches whether or not the user information transmitted at the terminal-side information transmitting step is stored at the limit information storing step, and reads out the limit function information and the alternative function information each of which is correlated to the user information when the user information is stored;
a changed information transmitting step in which the server changes apart of the function setting information, that corresponds to the limit function information, into the alternative function information, based on the limit function information and the alternative function information read out at the searching step, and transmits the changed function setting information to the client terminal; and
a preview display step in which the client terminal generates and displays a preview image of output data based on the changed function setting information transmitted at the changed information transmitting step.

9. An electronic device controlling method in an electronic device controlling system in which a server, a client terminal and an electronic device capable of outputting data via the server in response to an instruction from the client terminal are connected to a network, comprising:
a limit information storing step in which the server stores user information, limit function information showing a function usage of which is limited among functions of the electronic device, and alternative function information showing a function used as an alternative for the limiting function by correlating the above information to each other;
a terminal-side information transmitting step in which the client terminal transmits output data including the user information and function setting information used in the electronic device to the server;
a searching step in which the server searches whether or not the user information transmitted at the terminal-side information transmitting step is stored at the limit information storing step, and reads out the limit function information and the alternative function information each of which is correlated to the user information when the user information is stored;
a changed information transmitting step in which the server changes a part of the function setting information in the output data, that corresponds to the limit function information, into the alternative function information, based on the limit function information and the alternative function information read out at the searching step, and transmits the changed output data to the client terminal; and
a preview display step in which the client terminal generates and displays a preview image of output data based on the changed output data transmitted at the changed information transmitting step.

10. An electronic device controlling method in an electronic device controlling system in which a server and an electronic device capable of outputting data are connected to a network, comprising:
a limit information storing step in which the server store user information, limit function information showing a function usage of which is limited among functions of the electronic device, and alternative function information showing a function used as an alternative for the limiting function by correlating the above information to each other;
a device-side information transmitting step in which the electronic device transmits the user information to the server;
a searching step in which the server searches whether or not the user information transmitted at the device-side information transmitting step is stored at the limit information storing step, and reads out the limit function information and the alternative function information each of which is correlated to the user information when the user information is stored;
a changed information transmitting step in which the server transmits the limit function information and the alternative function information read out at the searching step to the electronic device; and
a preview display step in which the electronic device generates and displays a preview image of output data based on the limit function information and the alternative function information transmitted at the changed information transmitting step.

11. An electronic device controlling method in an electronic device controlling system in which a server and an electronic device capable of outputting data are connected to a network, comprising:
a limit information storing step in which the server stores user information, limit function information showing a function usage of which is limited among functions of the electronic device, and alternative function information showing a function used as an alternative for the limiting function by correlating the above information to each other;
a device-side information transmitting step in which the electronic device transmits the user information and function setting information used in the electronic device to the server;
a searching step in which the server searches whether or not the user information transmitted at the device-side information transmitting step is stored at the limit information storing step, and reads out the limit function information and the alternative function information each of which is correlated to the user information when the user information is stored;
a changed information transmitting step in which the server changes a part of the function setting information, that corresponds to the limit function information, into the alternative function information, based on the limit function information and the alternative function information read out at the searching step, and transmits the changed function setting information to the electronic device; and
a preview display step in which the electronic device generates and displays a preview image of output data based on the changed function setting information transmitted at the changed information transmitting step.

12. An electronic device controlling method in an electronic device controlling system in which a server and an electronic device capable of outputting data are connected to a network, comprising:
a limit information storing step in which the server stores user information, limit function information showing a function usage of which is limited among functions of the electronic device, and alternative function information showing a function used as an alternative for the limiting function by correlating the above information to each other;
a device-side information transmitting step in which the electronic device transmits output data including the user information and function setting information used in the electronic device to the server;
a searching step in which the server searches whether or not the user information transmitted at the device-side information transmitting step is stored at the limit information storing step, and reads out the limit function information and the alternative function information each of which is correlated to the user information when the user information is stored;
a changed information transmitting step in which the server changes a part of the function setting information in the output data, that corresponds to the limit function information, into the alternative function information, based on the limit function information and the alternative function information read out at the searching step, and transmits the changed output data to the electronic device; and
a preview display step in which the electronic device generates and displays a preview image of output data based on the changed output data transmitted at the changed information transmitting step.
